(19) United States
(12) Patent Application Publication
(10) Pub. No.: US 2007/0119843 A1
(43) Pub. Date: May 31, 2007

(54) Wall framing system

(75) Inventor: David M. Ball, Newport Coast, CA (US)

Correspondence Address: MICHAEL E. MARTIN;GARDERE WYNNE SEWELL LLP, IP SECTION, 3000 THANKSGIVING TOWER, 1601 ELM STREET, SUITE 3000, DALLAS, TX, 75201, US

(73) Assignee: LENNAR HOMES OF CALIFORNIA, INC, ALISO VIEJO, CA (US)

(21) Appl. No.: 11/281,174

(22) Filed: Nov. 17, 2005

(51) Int. Cl. H05B 3/00; H05B 11/00

(52) U.S. Cl. 219/213

(57) ABSTRACT

A wall framing system includes formed metal, channel shaped, upper and lower tracks, column or stud members and intermediate brace members which are interconnected and located relative to each other by inwardly facing circular projections formed on the track and brace members and cooperating circular recesses formed in the flanges of the column members. The configurations of the projections and recesses provide ease of locating and locking the framing members to each other. The track members and brace members are further secured to the column members with fasteners, such as self drilling screws, having heads which fit within recesses formed by the track and brace member projections. The framing system may be erected on site or prefabricated and transported to the building site.

### BACKGROUND OF THE INVENTION

The development of erected-on-site and prefabricated framing systems for various types of buildings including, in particular, residential dwellings, has increasingly favored the use of formed metal framing components, such as column or so-called stud members, horizontal upper and lower track members and other members needed for strength and rigidity of a wall frame. Several developments have taken place with respect to providing metal framing members which may be formed with means for attaching the column members to the track members. For example, U.S. Pat. No. 5,394,665 issued Mar. 7, 1995 to Johnson, and assigned to an affiliate of the assignee of the present invention, is directed to a framing system with column and track members formed with cooperating protrusions or projections of different geometries which are adapted to interlock the framing components. However, the geometries of the protrusions or projections somewhat limit the ability to engage one member with the other regardless of the direction of movement of the members relative to each other during assembly. Still further, it has been deemed desirable and necessary to reinforce the structural integrity of a framing system for building walls of various types whereby the framing members should also be secured to each other with mechanical fasteners, including self-drilling metal penetrating screws, for example.

There has also been a realization of the need for improvements in formed metal framing systems whereby framing members, such as column or stud members and track members, may be formed of sheet metal, including steel, of different thicknesses, and wherein there are provided cooperating projections and recesses in the members at points of connection therebetween. These features and the desirability of connecting the members with mechanical fasteners has resulted in the development of the present invention.

### SUMMARY OF THE INVENTION

The present invention provides an improved wall framing system, useful in the fabrication of various types of buildings, including residential dwelling units, in particular.

In accordance with one aspect of the present invention, a wall framing system is provided with cooperating vertical column and generally horizontal track or beam type framing members which are adapted to be interconnected and located precisely relative to each other by cooperating projections and recesses formed in such members, respectively. In particular, the projections of one member are formed to substantially nest in recesses formed in the cooperating member whereby the members may be quickly precisely located relative to each other and connected to each other.

Further in accordance with the invention, the interconnections between column and track members or between column and so-called blocking members may be reinforced by securing the members to each other with mechanical fasteners, including self-drilling type screws, for example. The screws have shallow or low height heads which are conveniently disposed in the dual purpose recess and projection portions of the track and blocking members to maintain a substantially planar surface for placement of paneling and other structures adjacent to or contiguous with the framing system.

In accordance with yet a further aspect of the present invention, a wall framing system is provided which includes cooperating column and horizontal beam or track members, as well as reinforcing or blocking members, wherein cooperating projections and recesses are formed which are substantially circular whereby the members may be more conveniently moved relative to each other into positions whereby the recesses and projections fully engage to at least temporarily lock the members together. In this way, cooperating frame members, such as column and track members, may be more quickly interconnected since the members may be moved relative to each other in different directions or in different ways and do not require precise alignment, initially, in order to obtain engagement between the projections on one member and the cooperating recesses on the other member.

Still further, the present invention contemplates the provision of a wall framing system which lends itself well to fabrication using continuous forming machinery for roll forming metal shapes, such as channel-shaped members which may or may not have reentrant distal flange portions. The framing system is dimensionally tolerant whereby framing members of different metal gauges may be interconnected while maintaining the integrity of connections between members at the locations of the cooperating projections and recesses formed in the respective members.

Accordingly, the present invention provides a metal wall framing system wherein the cooperating studs or column members and track members include built-in securing or connection means that allow the members to be snapped together at predetermined intervals or positions relative to each other and the connections may be reinforced with the use of mechanical fasteners, if desired. Accordingly, a system is provided which is easy to assemble and relatively inexpensive to manufacture and still further provides a framing system which is of superior strength.

Those skilled in the art will further appreciate the above-mentioned advantages and superior features of the invention, together with other important aspects thereof, upon reading the detailed description which follows in conjunction with the drawings.

### BRIEF DESCRIPTION OF THE DRAWINGS

FIG. 1 is a perspective view of a portion of a building which includes a wall framing system in accordance with the invention;

FIG. 2 is a detail perspective view showing a typical connection between a track member and a column or stud member for the framing system of the invention;

FIG. 3 is a side elevation of a column or stud member for the framing system of the invention;

FIG. 4 is a front elevation of the column member shown in FIG. 3;

FIG. 5 is a section view taken generally along the line 5-5 of FIG. 3;

FIG. 6 is a perspective view of a typical horizontal beam or track section for the framing system of the invention;

FIG. 7 is a perspective view of a track section showing a partial cut in the web portion of the track section for ease of removing unneeded portions of a track or beam member, such as at a doorway or window sill;

FIG. 8 is a section view taken generally along the line 8-8 of FIG. 6;

FIG. 9 is a section view showing the connections between a column member and upper and lower track members and taken in an orientation corresponding to the line 9-9 of FIG. 2;

FIG. 10 is a perspective view of a brace or blocking member for the wall framing system of the present invention; and

FIG. 11 is a table of certain dimensions for exemplary ones of track, column and blocking members in accordance with the invention.

### DETAILED DESCRIPTION OF A PREFERRED EMBODIMENT

In the description which follows like parts are marked throughout the specification and drawings with the same reference numerals, respectively. The drawing figures are not necessarily to scale and certain features may be shown exaggerated in scale or in somewhat generalized or schematic form in the interest of clarity and conciseness.

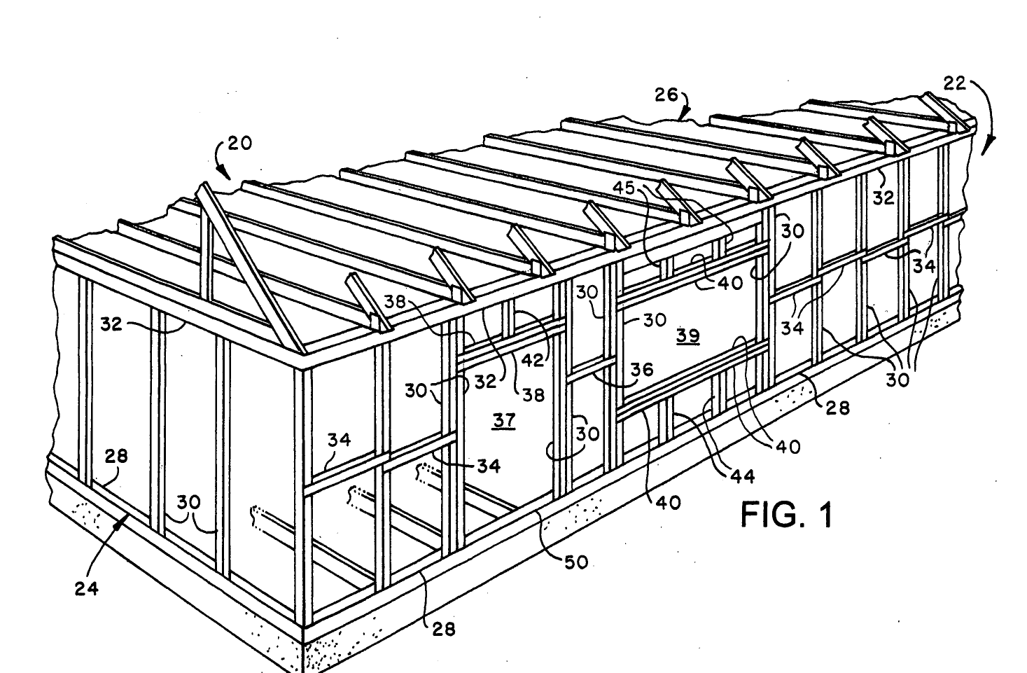

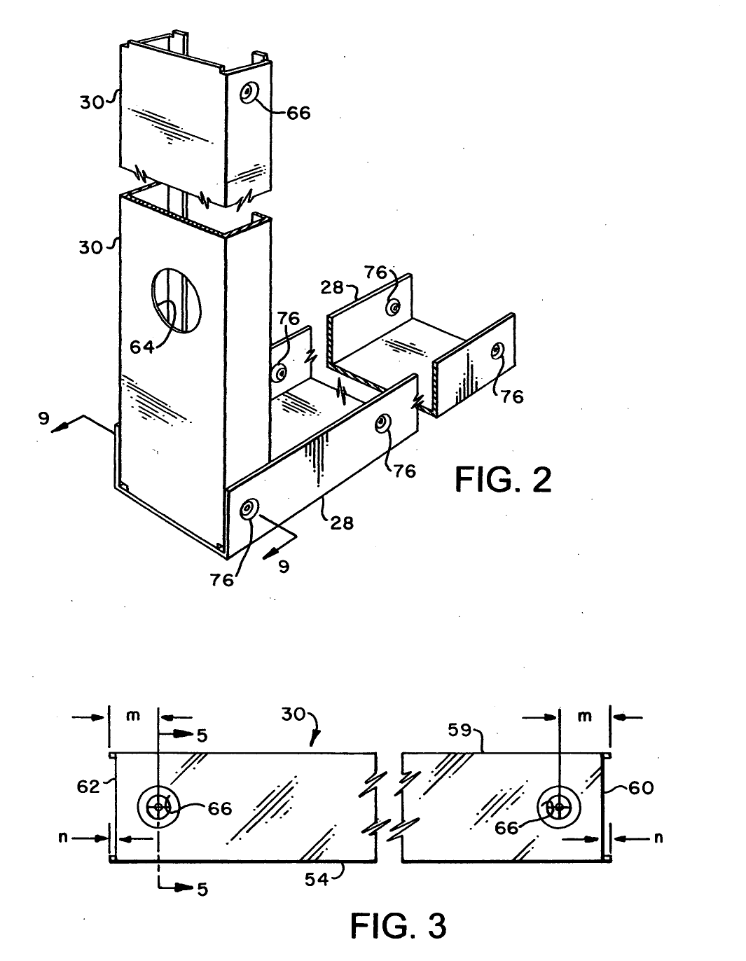

Referring to FIG. 1 there is shown a portion of a building, such as a residential dwelling unit, generally designated by the numeral 20 and including a wall framing system in accordance with the invention and generally designated by the numeral 22. Various types of building construction may utilize a wall framing system, such as the framing system 22. By way of example, the building 20 is characterized by a foundation 24, which may be of a perimeter or slab type, and a roof truss system 26.

Disposed between the foundation 24 and the truss system 26 is framing system 22, including elongated lower horizontal track members 28, which may be continuous or provided in predetermined segments for ease of transport and handling. Track members 28 are characterized as upturned channel shaped members, as will be described in further detail herein. Wall framing system 22 is also provided with spaced apart vertically extending column members 30 which are engaged with track members 28, extend vertically at predetermined spaced apart intervals and are engaged at their opposite ends with downwardly facing channel shaped upper track members 32, constructed substantially like the track members 28.

Various predetermined lengths of bracing or blocking members 34, 36, 38, and 40, for example, may be utilized to interconnect and reinforce adjacent column members 30 and to form framing members at doorways and windows, for example. In other words, bracing or blocking members may form at least portions of window framing for a window 39, for example, such as contiguous, back to back members 40 shown in FIG. 1. Similar bracing or blocking members may be used in outlining a doorway 37, such as indicated for the contiguous back to back framing or blocking members 38. Such bracing or blocking members may also be used to reinforce the framing system at various locations, such as indicated for the members 34. Each of brace or blocking members 34, 36, 38 and 40 are characterized by the same general configuration as will be described further herein, but may be formed of various lengths, as needed, to provide the requisite reinforcement or to outline the perimeter of a window or door, for example. In like manner, the column members 30 may be of various lengths, such as indicated for members 42, 44 and 45, for example, FIG. 1. Doorways and window frames may be reinforced by plural, generally contiguous back to back column members 30 and bracing members 38 and 40, as shown in FIG. 1.

The track members, such as members 28, may be cut away at various locations, including, for example, at the threshold of a doorway, as indicated by numeral 50 in FIG. 1. In this way at least one or more portions of a channel shaped track member may be eliminated when desired. Still further, the framing system 22 may be reinforced at particular locations, such as at doorways and windows, as mentioned above and shown in FIG. 1, by providing requisite strength of the framing system utilizing back to back arranged plural framing members.

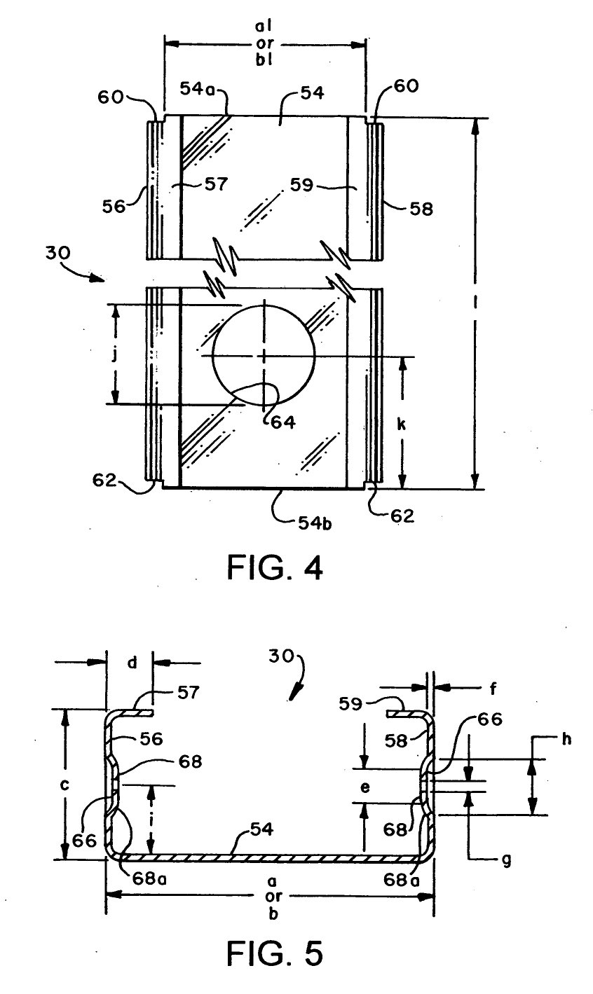

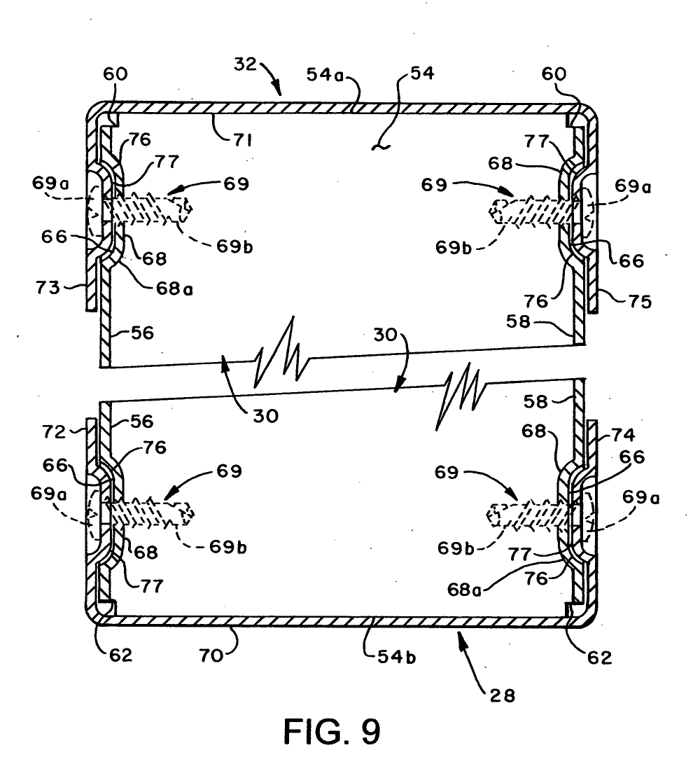

Referring now to FIGS. 3, 4, and 5, further details of a typical one of the column or stud members 30 are illustrated. Column or stud member 30 may be formed of sixteen gauge to twenty-two gauge galvanized steel and having the respective dimensions indicated in drawing FIGS. 3 through 5 and as set forth in the table of FIG. 11. The dimensions a through n, a1 and b1 given in the table of FIG. 11 are exemplary and are typical for the material thicknesses specified. Column members 30 are characterized as channel shaped members having a transverse web part 54 and opposed flanges 56 and 58, FIGS. 3 through 5. Flanges 56 and 58 are provided with reentrant distal edge portions or lips 57 and 59, respectively, and substantially parallel to web 54. The web 54 and the flanges 56 and 58 may be notched at their opposite ends, as indicated by numerals 60 and 62, whereby the longitudinal extent of a major portion of web 54 and of portions of the reentrant edges or lips 57 and 59, if provided for a column member 30, is greater than the flanges 56 and 58 at opposite ends 54a and 54b, respectively. Such configuration of the web and flanges of column members 30 provide clearance at the radii formed at the juncture of the flanges and webs of the cooperating track members 28 and 32 when the members 30 are inserted within the confines of the channel shaped track members, as illustrated in FIG. 9. As shown in FIG. 4, each column member 30 may have one or more utility conductor holes 64 formed therein, one shown in FIG. 4, to allow for training of utility conductors, not shown, along the wall framing system 22, as needed.

As shown in FIGS. 3 and 5, the column members 30 each include at least four spaced apart circular recesses 66 formed in the flanges 56 and 58, as illustrated. Recesses 66 are formed in opposed pairs in alignment with each other on flanges 56 and 58. Recesses 66 preferably are formed with the dimensions e, f, g and h for receiving cooperating projections formed on track members 28 as will be further described. Recesses 66 are advantageously circular in configuration and relatively shallow, that is, having a depth not substantially exceeding the wall thickness of the flanges 56 or 58, for example. Recesses 66 are also defined by a substantially planar and circular flat bottom wall part 68 integral with a curved, annular, transition part 68a, FIG. 5, for transition to flange 56 or 58. Recesses 66 may be formed by a suitable coining, punch or similar metal displacement operation. Recesses 66 are each also provided with fastener receiving and locating or “pilot” holes centered in the recesses and identified by the dimension g in FIG. 5, for example. The location of the center of each of the recesses 66 is indicated by dimension i in FIG. 5. Hole diameter g is suitable for a fastener receiving pilot hole and for allowing a self-drilling or self-tapping screw, such as a panhead self-drilling screw 69, see FIG. 9, to be used for fastening members 28 and 32 to members 30, for example.

Other mechanical fasteners, such as rivets, may be used, however, fasteners 69 are preferred for the embodiments described in detail herein. Screws 69 may be of a type commercially available under the trademark GRABBER from Grabber Construction Products Division of John Wagner Associates, Inc. Screws 69 are operable to be threadedly engaged with the wall 68 upon assembly of a column member 30 to a track member 28 or 32 or to a blocking or brace member 34, 36, 38 or 40. For the exemplary sizes and dimensions of members 28, 30, 32 and 34 given herein a preferred screw size is a no. 10 panhead self-drilling screw of about 0.75 inches overall length and including a no. 2 Phillips drive. Other drive configurations may be provided. Screws 69, as shown in FIG. 9, include circular pan heads 69a and self-drilling threaded shanks 69b.

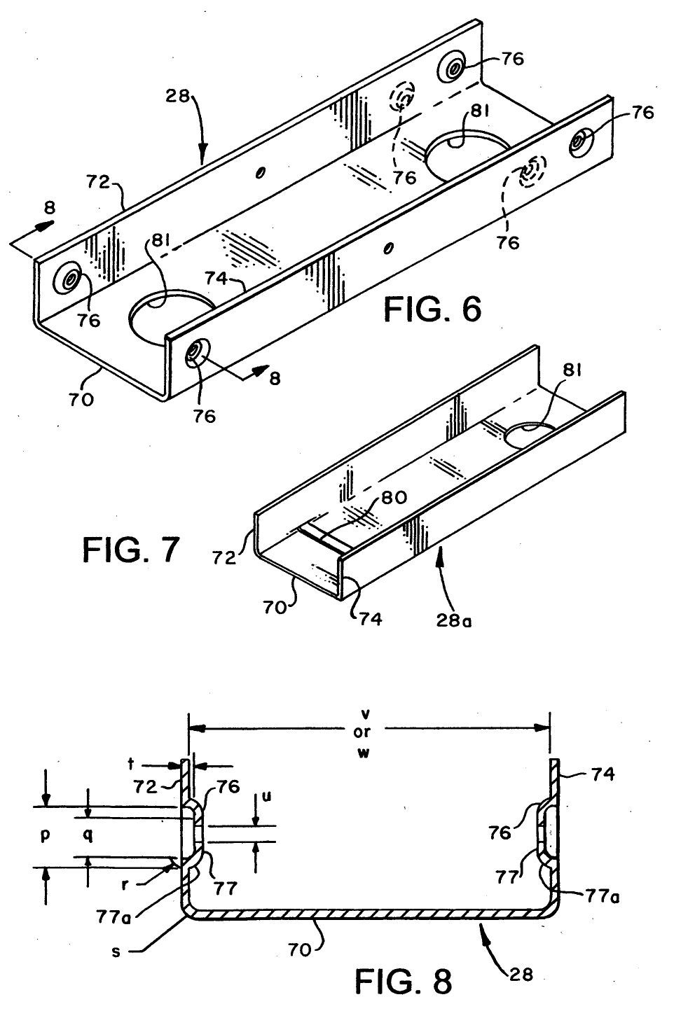

Referring now to FIGS. 6 through 8, track members 28 and 32 are characterized by a configuration, as shown for track member 28, which is defined by a base or web portion 70, opposed parallel flanges 72 and 74 and spaced apart pairs of inwardly facing opposed projections 76 which may be located on the flanges 72 and 74 at predetermined positions. Projections 76 are also formed by a coining, punch or similar operation for displacing material of the flanges 72 and 74, as illustrated, and to the dimensions p through u, as indicated in FIG. 8. Exemplary values for dimensions p through w are shown in FIG. 11. Projections 76 are located on flanges 72 and 74 in such a way as to engage the flanges of column members 30 at the recesses 66, respectively, to forcibly register or connect the members with each other. Projections 76 are also circular and dimensioned to conform to and register with the recesses 66 in the manner illustrated in FIG. 9. Projections 76 are also defined by circular and planar or flat walls 77 substantially parallel to flanges 72 and 74. Walls 77 are integral with curved annular transition parts 77a which are integral with flanges 72 or 74, respectively.

Screw fastener pilot holes of dimension u are preferably formed centered in walls 77. The diameters q of circular walls 77 are at least as great as the diameters of screw heads 69a and any washer or the like, not shown, larger than the screw head and placed thereunder. Accordingly, the flanges 72 and 74, as well as the flanges 56 and 58 may be elastically deflected to allow the projections 76 to register in the recesses 66 of a column member and connections between members 28 and 30 and between members 30 and 32 are then reinforced by securing the members to each other with the mechanical fasteners 69, as illustrated in FIG. 9. As shown in FIG. 9 also, the heights of fastener heads 69a do not cause the heads to project substantially above the surfaces of flanges 72 and 74, thanks to the recesses formed by the projections 76, respectively.

As shown in FIG. 6, additional projections 76 may be located along the flanges 72 and 74, as needed, and disposed relatively close to each other in situations wherein column members are placed directly adjacent to each other at high stress locations in the framing system 22. As shown in FIG. 7, any one of the track members may be modified to provide a member 28a, for example, as needed, by providing a slot or relief cut 80 transversely between the flanges 72 and 74, to provide ease of cutting away unneeded portions of respective track members. For example, at the doorway 37 shown in FIG. 1, track members 28 may be dimensioned such that the transverse slot 80 is cut completely through web 70 and through the radius portions of respective track member between web 70 and flanges 72 and 74, respectively, to facilitate ease of cutting away unneeded parts of the track member. Utility openings 81, FIGS. 6 and 7, may also be provided in track members 28 or 28a, as illustrated.

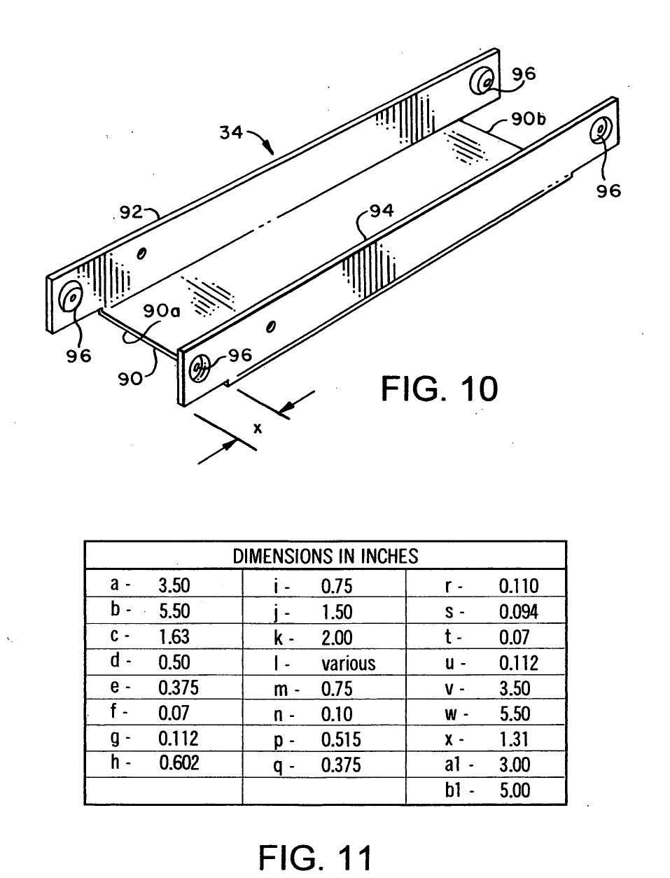

Referring briefly to FIG. 10, there is illustrated one of the brace or blocking members 34 which is characterized by a channel shaped member having a web portion 90 and opposed parallel flanges 92 and 94. Inwardly facing opposed projections 96, corresponding substantially to the projections 76, may be formed in the flanges 92 and 94, as illustrated, for registering in selectively positioned recesses 66 of column members 30 and the like for locating and securing the brace or blocking members 34 in the framing system 22. For the dimensions given herein in the table of FIG. 11, the flanges 92 and 94 extend beyond the transverse ends 90a and 90b of the web 90 by a dimension x to allow these members to engage column members 30, for example, as illustrated in FIG. 1. Bracing, or brace or blocking members 37, 38 and 40 are essentially constructed the same as members 34, but are of various predetermined lengths, as needed.

Track member 32 is defined by a web 71 and opposed flanges 73 and 75 in which opposed pairs of projections 76 are formed for engaging recesses of the opposite end of column members 30, as shown in FIG. 9. The distances between the inside or facing surfaces of the flanges of members 28, 28a, 30 and 34, for example, should remain constant regardless of the gauge or thickness of material being used to form these members. However, the distances between the outwardly facing surfaces of the flanges 56 and 58 of column members 30 will vary with the gauge or material thickness of the column members 30. Accordingly, the members 28, 30 and 32 are dimensioned to fit together, as illustrated in FIG. 9, such that the recesses 66 are engaged by the projections 76 or 96 (projections 76 are shown in FIG. 9) regardless of variations in material thickness or gauge. However, when the screw fasteners 69 are inserted through the pilot holes or openings in the projection walls 77 to forcibly engage the recess walls 68 and then tightened, any gap between the walls 77 and 68 will be closed. Still further, the locations of the recesses 66 on column members 30 and projections 76 on the track members 28 and 32 are such that the opposite ends 54a and 54b of webs 54 substantially fully engage the track webs 71 and 70, respectively, as shown in FIG. 9. The relieved edges 90a and 90b of brace members 34, FIG. 10, are also adapted to engage webs 54 of cooperating column members 30 when these members are assembled to each other. Accordingly greater surface area of contact for load bearing is accomplished with the framing system 22 of the invention.

Framing component forming systems for fabricating the components described hereinabove are commercially available, such as from Knudson Mfg., Inc. of Broomfield, Colo. Such forming systems are operable to form the shapes of the components, the component lengths, and the recesses and projections on the respective components including the requisite locations of such projections and recesses. Accordingly, by predetermining the locations of the projections and recesses on the track components and the brace or blocking members, as well as on the column members, all of these members may be located relative to each other and locked together in their correct positions without any further measurements being required by persons fabricating a structure utilizing a wall framing system, such as the framing system 22. In this way, the speed with which a framing system may be erected is substantially improved. Still further, preplacement of the recesses and projections on the respective components of the framing system, together with use of mechanical fasteners which are located by use of the pilot or clearance holes in the recesses and projections also facilitates the ease with which the framing system may be constructed and secured. Fabrication of the framing system components and erection or assembly of wall framing system 22 is believed to be within the purview of one skilled in the art based on the foregoing description.

A preferred embodiment of a wall framing system in accordance with the invention has been described in detail hereinabove. Wall framing systems such as the system 22 may be erected on site or substantially prefabricated in many particular versions or configurations utilizing the components 28, 30, 32, 34, 36, 38, 40, 42, 44 and 45, for example, in accordance with the invention. Components 32 and 28 are of identical construction, typically, and the components 28, 30, 32, 34, 36, 38, 40, 42, 44 and 45 may be of various lengths as will be appreciated by those skilled in the art. However, thanks to the configurations of these members and the improved configuration of the projections and cooperating recesses formed in the respective members, together with the fasteners used to reinforce the connections between members, an improved wall framing system is realized. Although a preferred embodiment of the invention has been described in detail, those skilled the art will also recognize that various substitutions and modifications may be made without departing from the scope and spirit of the appended claims.

What is claimed is:

1. A wall framing system comprising:
an elongated lower channel shaped track having opposed flanges;
an elongated upper channel shaped track having opposed flanges and aligned with and vertically spaced from said lower track;
a plurality of spaced apart vertically aligned column members positioned between said tracks, each of said column members having lower and upper end portions positioned within and between said opposed flanges of said tracks, respectively;
inwardly extending projections formed opposite each other on said opposed flanges of said tracks, respectively;
opposed recesses formed on walls of upper and lower end portions of said column members, respectively, and operable to engage said projections on said tracks for locating and locking said column members in predetermined positions between said tracks; and
said projections and said walls defining said recesses receiving fasteners for securing said column members to said tracks, respectively.

2. The system set forth in claim 1 wherein:
said projections and said recesses are substantially circular in configuration.

3. The system set forth in claim 1 wherein:
said projections are each defined by a displaced wall portion of said flanges to form a recess for receiving a head part of one of said fasteners, respectively.

4. The system set forth in claim 3 wherein:
the depths of said recesses formed by said projections from respective outwardly facing surfaces of said flanges are one of about equal to or greater than the heights of said head parts of said fasteners, respectively.

5. The system set forth in claim 3 wherein:
said wall portions defining said projections are planar and circular and have a diameter at least as great as the diameters of said head parts of said fasteners, respectively.

6. The system set forth in claim 1, including:
transverse slots formed in said tracks at selected positions thereon to facilitate removal of portions of said tracks at doorways and the like by severing said portions of said tracks at said flanges, respectively.

7. The system set forth in claim 1 including:
elongated channel shaped brace members extending between adjacent ones of said column members at selected positions on said system, said brace members including opposed flanges and a web interconnecting said flanges, said flanges of said brace members extending at opposite ends of said brace members beyond a longitudinal extent of said webs of said brace members, respectively, and inwardly extending projections formed on said flanges of said brace members adapted for engagement with said column members at cooperating recesses formed in said column members between opposite ends thereof, respectively.

8. The system set forth in claim 1 wherein:
walls defining said projections of said tracks include at least one of a fastener pilot hole and a fastener clearance hole formed therein for receiving one of said fasteners, respectively.

9. The system set forth in claim 8 wherein:
said fasteners comprise self drilling screws and walls defining said recesses in said column members include pilot holes therein, respectively, for receiving one of said fasteners for securing said column members to said tracks, respectively.

10. The system set forth in claim 1 wherein:
said column members comprise channel shaped members having a web portion and said opposed flanges are integrally joined to said web portion, the longitudinal extent of said web portion being at least slightly greater than the longitudinal extent of said flanges at opposite ends of said column members, respectively.

11. The system set forth in claim 10 wherein:
said flanges of said column members include reentrant distal end portions extending toward each other.

12. A wall framing system comprising:
an elongated lower channel shaped track having opposed flanges;
an elongated upper channel shaped track having opposed flanges and aligned with and vertically spaced from said lower track;
a plurality of spaced apart vertically aligned channel shaped column members positioned between said tracks, each of said column members having lower and upper end portions positioned within and between said opposed flanges of said tracks, respectively;
inwardly extending circular projections formed opposite each other on said opposed flanges of said tracks, respectively;
opposed circular recesses formed on opposed flanges at upper and lower end portions of said column members, respectively, and operable to engage said projections on said tracks for locating and locking said column members in predetermined positions between said tracks; and
said projections and said recesses are each defined by a displaced wall portion of said flanges of said tracks and said column members, respectively; and
said projections and said recesses receiving screw fasteners for securing said column members to said tracks, respectively.

13. The system set forth in claim 12 wherein:
the depths of said recesses formed by said projections from respective outwardly facing surfaces of said flanges are one of about equal to or greater than the heights of head parts of said fasteners, respectively.

14. The system set forth in claim 12 wherein:
said wall portions defining said projections are planar and circular and have a diameter at least as great as the diameters of head parts of said fasteners, respectively.

15. The system set forth in claim 12, including:
transverse slots formed in said tracks at selected positions thereon to facilitate removal of portions of said tracks at doorways and the like by severing said portions of said tracks at said flanges, respectively.

16. The system set forth in claim 12 including:
elongated channel shaped brace members extending between adjacent ones of said column members at selected positions on said system, said brace members including opposed flanges and a web interconnecting said flanges, said flanges of said brace members extending at opposite ends of said brace members beyond a longitudinal extent of said webs of said brace members, respectively, and inwardly extending projections formed on said flanges of said brace members adapted for engagement with said column members at cooperating recesses formed in said column members between opposite ends thereof, respectively.

17. The system set forth in claim 12 wherein:
said projections of said tracks include at least one of a fastener pilot hole and a fastener clearance hole formed therein for receiving one of said fasteners, respectively.

18. The system set forth in claim 17 wherein:
said recesses in said column members include pilot holes therein, respectively, for receiving one of said fasteners for securing said column members to said tracks, respectively.

19. The system set forth in claim 12 wherein:
said column members each include a web portion and said opposed flanges are integrally joined to said web portion, the longitudinal extent of said web portion being at least slightly greater than the longitudinal extent of said flanges at opposite ends of said column members, respectively.

20. A wall framing system comprising:
an elongated lower channel shaped track having opposed flanges;
an elongated upper channel shaped track having opposed flanges and aligned with and vertically spaced from said lower track;
a plurality of spaced apart vertically aligned column members positioned between said tracks, each of said column members having lower and upper end portions positioned within and between said opposed flanges of said tracks, respectively;
inwardly extending circular projections formed opposite each other on said opposed flanges of said tracks, respectively; and
opposed circular recesses formed on walls of upper and lower end portions of said column members, respectively, and operable to engage said projections on said tracks for locating and locking said column members in predetermined positions between said tracks.

21. The system set forth in claim 20 including:
elongated channel shaped brace members extending between adjacent ones of said column members at selected positions on said system, said brace members including opposed flanges and a web interconnecting said flanges of said brace members, said flanges of said brace members extending at opposite ends of said brace members beyond a longitudinal extent of said webs of said brace members, respectively, and inwardly extending circular projections formed on said flanges of said brace members engaged with said column members at cooperating recesses formed in said column members between opposite ends thereof, respectively.

22. The system set forth in claim 21 wherein:
said projections and said recesses are each defined by displaced wall portions of said tracks and said members, respectively.

23. The system set forth in claim 21 wherein:
said projections and said recesses receiving screw fasteners for securing said column members to said tracks and said brace members to said column members, respectively.

24. The system set forth in claim 23 wherein:
the depths of recesses formed by said projections from respective outwardly facing surfaces of said flanges of respective ones of said tracks and said brace members are one of about equal to or greater than the heights of head parts of said fasteners, respectively.

25. The system set forth in claim 24 wherein:
said wall portions defining said projections are planar and circular and have a diameter at least as great as the diameters of said head parts of said fasteners, respectively.

26. The system set forth in claim 20 wherein:
the locations of said projections on said tracks and said recesses on said column members are predetermined to provide for connecting said column members and said tracks in dimensionally correct positions without further measurement required to locate said column members and said tracks with respect to each other.

27. The system set forth in claim 26 wherein:
said projections and said recesses each include openings therein providing one of clearance for and a pilot opening for guiding a mechanical fastener to secure a column member to a track at the locations of cooperating recesses and projections, respectively.
